(19) United States
(12) Patent Application Publication
(10) Pub. No.: US 2025/0158648 A1
(43) Pub. Date: May 15, 2025

(54) RADIO FREQUENCY MODULE AND COMMUNICATION DEVICE

(71) Applicant: Murata Manufacturing Co., Ltd., Nagaokakyo-shi (JP)

(72) Inventor: Shinichiro TAKAYANAGI, Nagaokakyo-shi (JP)

(21) Appl. No.: 18/812,117

(22) Filed: Aug. 22, 2024

(30) Foreign Application Priority Data
Nov. 15, 2023 (JP) 2023-194646

(51) Int. Cl. H04B 1/04

(52) U.S. Cl. CPC H04B 1/0483; H04B 1/0475; H04B 2001/0408

(57) ABSTRACT

A radio frequency module according to an exemplary aspect the present disclosure includes a power amplifier, an external connection terminal configured to receive a power supply voltage that is output from a tracker module and a switch configured to perform switching of a selected path among a plurality of paths for coupling the external connection terminal with the power amplifier, the plurality of paths are configured to have different delay times.

### CROSS REFERENCE TO RELATED APPLICATIONS

This application claims priority to Japanese Patent Application No. 2023-194646, filed Nov. 15, 2023, the entire content of the prior application is hereby incorporated by reference in its entirety.

### BACKGROUND

The present disclosure relates to a radio frequency module and a communication device and in more detail, relates to a radio frequency module including a power amplifier and a communication device including the radio frequency module.

An example circuit, such as U.S. Patent Application Publication No. 2020/0350866, describes the inclusion of a delay element between a tracker and a power amplifier to synchronize a power supply voltage output from the tracker (a tracker module) to the power amplifier with a radio frequency signal.

However, in the radio frequency module described in U.S. Patent Application Publication No. 2020/0350866, there is the same duration of delay in the power supply voltage output from the tracker module to the power amplifier at any temperature, and thus an inappropriate duration of delay in the power supply voltage occurs depending on the temperature variation. Deterioration in EVM characteristics or the like thus occurs on occasions.

### SUMMARY OF THE INVENTION

The present disclosure has been made in consideration of the point above, and according to some exemplary aspects, it is an object thereof to provide a radio frequency module and a communication device that reduce characteristic deterioration with temperature variations.

In particular, a radio frequency module according to an exemplary aspect of the present disclosure includes a power amplifier, an external connection terminal, and a switch. The external connection terminal is connected to a tracker module and the power amplifier. The tracker module outputs a power supply voltage to the power amplifier. The switch selectively performs switching of a path connecting the external connection terminal and the power amplifier from among a plurality of paths involved with mutually different delay times.

A radio frequency module according to an exemplary aspect of the present disclosure includes a power amplifier, an external connection terminal, and a thermistor. The external connection terminal is connected to a tracker module and the power amplifier. The tracker module outputs a power supply voltage to the power amplifier. The thermistor is connected to a path connecting the external connection terminal and the power amplifier.

A radio frequency module according to an exemplary aspect the present disclosure includes a power amplifier, an external connection terminal configured to receive a power supply voltage that is output from a tracker module and a switch configured to perform switching of a selected path among a plurality of paths for coupling the external connection terminal with the power amplifier, the plurality of paths are configured to have different delay times.

A radio frequency module according to an exemplary aspect of the present disclosure includes a power amplifier, an external connection terminal configured to receive a power supply voltage that is output from a tracker module, and a thermistor that is disposed on a path connecting the external connection terminal with the power amplifier.

A radio frequency module according to an exemplary aspect of the present disclosure includes a power amplifier, an external connection terminal configured to receive a power supply voltage that is output from a tracker module, and a variable delay circuit disposed on a power providing path for providing the power supply voltage from the external connection terminal to the power amplifier. The variable delay circuit is configured to adjust a delay time of the power supply voltage.

A communication device according to an exemplary aspect of the present disclosure includes the radio frequency module, a tracker module, and a signal processing circuit. The signal processing circuit is connected to the radio frequency module.

With the radio frequency module and the communication device according to the exemplary aspects of the present disclosure, characteristic deterioration with temperature variations may be reduced.

### BRIEF DESCRIPTION OF THE DRAWINGS

FIG. 1 is a block diagram of a radio frequency module and a communication device according to exemplary Embodiment 1;

FIG. 2 is a circuit diagram of a delay circuit of the radio frequency module according to exemplary Embodiment 1;

FIG. 3 is a waveform diagram illustrating a relationship between a radio frequency signal and a power supply voltage across a power amplifier in the radio frequency module according to exemplary Embodiment 1;

FIG. 4 is a waveform diagram illustrating a relationship between a power supply voltage across a power amplifier in a radio frequency module in Comparative Example 1 and a radio frequency signal;

FIG. 5 is a waveform diagram illustrating a relationship between a power supply voltage across a power amplifier in a radio frequency module according to a modification of exemplary Embodiment 1 and a radio frequency signal;

FIG. 6 is a waveform diagram illustrating a relationship between a power supply voltage across a power amplifier in a radio frequency module in Comparative Example 2 and a radio frequency signal;

FIG. 7 is a block diagram of a radio frequency module and a communication device according to exemplary Embodiment 2;

FIG. 8 is a block diagram of a radio frequency module and a communication device according to exemplary Embodiment 3; and

FIG. 9 is a block diagram of a radio frequency module and a communication device according to exemplary Embodiment 4.

### DETAILED DESCRIPTION OF EMBODIMENTS

Hereinafter, a radio frequency module 1 and a communication device 8 according to exemplary Embodiments 1 to 4 will be described with reference to the drawings.

### Exemplary Embodiment 1

### 1. Radio Frequency Module

The configuration of the radio frequency module 1 according to exemplary Embodiment 1 will be described with reference to the drawings.

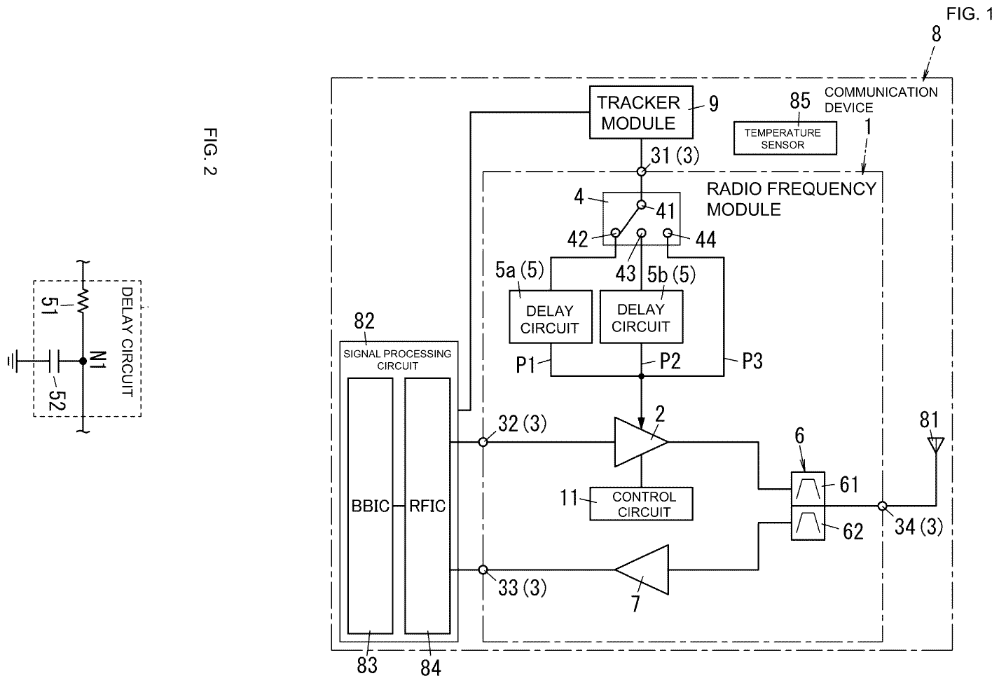

As illustrated in FIG. 1, the radio frequency module 1 according to exemplary Embodiment 1 includes a power amplifier 2, an external connection terminal 31, and a switch 4. The external connection terminal 31 is connected to a tracker module 9 and the power amplifier 2, the tracker module 9 outputting a power supply voltage to the power amplifier 2. The switch 4 selectively performs switching of a path connecting the external connection terminal 31 and the power amplifier 2 from among a plurality of paths P1 to P3 involved with mutually different delay times.

The radio frequency module 1 according to exemplary Embodiment 1 enables a temperature-appropriate delay time to be selected, and thus characteristic deterioration with temperature variations may be reduced.

### 2. Components of Radio Frequency Module

Hereinafter, components of the radio frequency module according to exemplary Embodiment 1 will be described with reference to the drawings.

As illustrated in FIG. 1, the radio frequency module 1 according to exemplary Embodiment 1 includes the power amplifier 2, a plurality of (in the illustrated example, four) external connection terminals 3, the switch 4, a plurality of (in the illustrated example, two) delay circuits 5, a duplexer 6, a low-noise amplifier 7, and a control circuit 11.

### 2.1 Power Amplifier

As illustrated in FIG. 1, the power amplifier 2 amplifies a transmission signal from a signal processing circuit 82 and outputs the transmission signal. The power amplifier 2 is disposed on a transmit path connected to an external connection terminal 32. The power amplifier 2 amplifies the transmission signal from the signal processing circuit 82 and outputs the transmission signal. In more detail, the power amplifier 2 is configured to amplify the transmission signal (a radio frequency signal) in response to the power supply voltage from the tracker module 9 being applied to the power amplifier 2, the transmission signal being input from the signal processing circuit 82 via the external connection terminal 32.

The power amplifier 2 has an input terminal and an output terminal. The input terminal of the power amplifier 2 is connected to the external connection terminal 32. The input terminal of the power amplifier 2 is thus connected to the signal processing circuit 82 with the external connection terminal 32 interposed therebetween. The output terminal of the power amplifier 2 is connected to the duplexer 6.

### 2.2 External Connection Terminals

As illustrated in FIG. 1, the plurality of external connection terminals 3 include the external connection terminal 31, the external connection terminal 32, an external connection terminal 33, and an external connection terminal 34. The external connection terminal 31 is connected to the tracker module 9 and the power amplifier 2. The external connection terminal 31 is a terminal configured to output the power supply voltage from the tracker module 9 to the power amplifier 2. The external connection terminal 32 is a signal input terminal configured to input the transmission signal (radio frequency signal) from the signal processing circuit 82 to the radio frequency module 1. The external connection terminal 33 is a signal output terminal for outputting a reception signal (radio frequency signal) from the radio frequency module 1 to the signal processing circuit 82. The external connection terminal 34 is an antenna terminal to which an antenna 81 is connected.

### 2.3 Switch

As illustrated in FIG. 1, the switch 4 is a switch connected to the paths between the external connection terminal 31 and the power amplifier 2. The switch 4 has a common terminal 41 and a plurality of (in the illustrated example, three) selection terminals 42 to 44. The common terminal 41 is connected to the external connection terminal 31. The common terminal 41 is thus connected to the tracker module 9 with the external connection terminal 31 interposed therebetween. The selection terminal 42 is connected to a delay circuit 5a. The selection terminal 42 is thus connected to the power amplifier 2 with the delay circuit 5a interposed therebetween. The selection terminal 43 is connected to a delay circuit 5b. The selection terminal 43 is thus connected to the power amplifier 2 with the delay circuit 5b interposed therebetween. The selection terminal 44 is connected to the power amplifier 2.

The switch 4 is a switch that is configured to control at least one or more of the plurality of selection terminals 42 to 44 to be connected to the common terminal 41. For example, the switch 4 is a switch that can configure one-to-one and/or one-to-many connections.

The switch 4 is controlled by a controller (not illustrated). The switch 4 is configured to perform switching of a state of connection between the common terminal 41 and one of the plurality of selection terminals 42 to 44 in accordance with a control signal from the controller. The switch 4 is, for example, a switch integrated circuit (IC).

### 2.4 Delay Circuits

As illustrated in FIG. 1, the plurality of delay circuits 5 include the delay circuit 5a and the delay circuit 5b.

The delay circuit 5a is disposed on the path P1 between the external connection terminal 31 and the power amplifier 2. In more detail, the delay circuit 5a is disposed on a path included in the path P1 and located between the selection terminal 42 of the switch 4 and the power amplifier 2.

In some exemplary embodiments, when the common terminal 41 is connected to the selection terminal 42 in the switch 4, the delay circuit 5a serves as a supply path for the power supply voltage and delays the power supply voltage. In contrast, when the common terminal 41 of the switch 4 is not connected to the selection terminal 42, the delay circuit 5a does not serve as the supply path for the power supply voltage.

The delay circuit 5b is disposed on the path P2 between the external connection terminal 31 and the power amplifier 2. In more detail, the delay circuit 5b is disposed on a path included in the path P2 and located between the selection terminal 43 of the switch 4 and the power amplifier 2.

In some exemplary embodiments, when the common terminal 41 is connected to the selection terminal 43 in the switch 4, the delay circuit 5b serves as the supply path for the power supply voltage and delays the power supply voltage. In contrast, when the common terminal 41 of the switch 4 is not connected to the selection terminal 43, the delay circuit 5b does not serve as the supply path for the power supply voltage.

### 2.5 Path Switching

As illustrated in FIG. 1, the delay circuit 5a and the delay circuit 5b are respectively disposed on the path P1 and the path P2 of the plurality of paths P1 to P3. That is, a delay circuit is not disposed on the path P3. The plurality of paths P1 to P3 are involved with mutually different delay times.

The switch 4 can be configured to selectively perform switching of the path connecting the external connection terminal 31 and the power amplifier 2 from among the plurality of paths P1 to P3. A temperature-appropriate delay time may thereby be selected, and characteristic deterioration with temperature variations may thus be reduced.

The switch 4 performs switching of the path connecting the external connection terminal 31 and the power amplifier 2 on a temperature basis. In more detail, the switch 4 performs switching of the path connecting the external connection terminal 31 and the power amplifier 2 based on temperature measured with a temperature sensor 85 (described later) and association between the temperature and the path. The association between the temperature and the path is stored, for example, in a memory (not illustrated) of the radio frequency module 1. The switch 4 performs switching of the path connecting the external connection terminal 31 and the power amplifier 2 from among the plurality of paths P1 to P3 based on information regarding the path associated with the temperature measured with the temperature sensor 85.

In exemplary Embodiment 1, the path P3 of the plurality of paths P1 to P3 is formed solely from a wiring conductor. The number of elements for causing the delay times may thereby be reduced, and thus paths involved with the delay times may be formed readily. When the path P3 is formed solely from the wiring conductor, for example, the delay time thereof may be set by adjusting at least one of the length or the width of the wiring conductor forming the path P3.

### 2.6 Circuit Configuration of Delay Circuits

As illustrated in FIG. 2, each delay circuit 5 includes an RC circuit having a resistor 51 and a capacitor 52 as main components. The delay circuit 5 has the resistor 51 and the capacitor 52.

Each resistor 51 is disposed on a corresponding one of the paths between the external connection terminal 31 and the power amplifier 2. For example, the resistor 51 of the delay circuit 5a is disposed on the path P1 between the external connection terminal 31 and the power amplifier 2. The resistor 51 of the delay circuit 5b is disposed on the path P2 between the external connection terminal 31 and the power amplifier 2. In more detail, the resistor 51 is disposed on the corresponding path between the switch 4 and the power amplifier 2. For example, the resistor 51 of the delay circuit 5a is disposed on a path included in the path P1 and located between the selection terminal 42 of the switch 4 and the power amplifier 2. The resistor 51 of a delay circuit 5b is disposed on a path included in the path P2 and located between the selection terminal 43 of the switch 4 and the power amplifier 2.

Each capacitor 52 is disposed on a corresponding one of paths between the ground and the corresponding path between the external connection terminal 31 and the power amplifier 2. For example, the capacitor 52 of the delay circuit 5a is disposed on a path between the ground and the path P1 between the external connection terminal 31 and the power amplifier 2. The capacitor 52 of the delay circuit 5b is disposed on a path between the ground and the path P2 between the external connection terminal 31 and the power amplifier 2. In more detail, the capacitor 52 is disposed on the path between the ground and a node N1 on the path between the resistor 51 and the power amplifier 2. For example, the capacitor 52 of the delay circuit 5a is disposed on a path between the ground and the node N1 on a path included in the path P1 and located between the selection terminal 42 of the switch 4 and the power amplifier 2. The capacitor 52 of the delay circuit 5b is disposed on a path between the ground and the node N1 on a path included in the path P2 and located between the selection terminal 43 of the switch 4 and the power amplifier 2.

Each delay circuit 5 adjusts a time of delay in output relative to input by using respective time constants of the resistor 51 and the capacitor 52. In more detail, the delay circuit 5 adjusts the delay time for the power supply voltage by using the resistance value of the resistor 51 and the capacitance of the capacitor 52. The higher the resistance value of the resistor 51 and the capacitance of the capacitor 52, the longer the delay time for the power supply voltage.

### 2.7 Duplexer

As illustrated in FIG. 1, the duplexer 6 has a transmission filter 61 and a reception filter 62. The transmission filter 61 is a filter having a passband including, for example, the communication band of a transmission signal. The transmission filter 61 is, for example, a bandpass filter. The reception filter 62 is a filter having a passband including, for example, the communication band of a reception signal. The reception filter 62 is, for example, a bandpass filter.

### 2.8 Low-Noise Amplifier

As illustrated in FIG. 1, the low-noise amplifier 7 is configured to amplify a reception signal (radio frequency signal) from the antenna 81.

The low-noise amplifier 7 has an input terminal and an output terminal. The low-noise amplifier 7 is disposed on a receive path connected to the external connection terminal 33. The low-noise amplifier 7 amplifies the reception signal input to the input terminal and outputs the reception signal from the output terminal. The input terminal of the low-noise amplifier 7 is connected to the duplexer 6. The output terminal of the low-noise amplifier 7 is connected to the external connection terminal 33. The output terminal of the low-noise amplifier 7 is thus connected to the signal processing circuit 82 with the external connection terminal 33 interposed therebetween.

### 3. Communication Device

As illustrated in FIG. 1, the communication device 8 includes the radio frequency module 1, the tracker module 9, the antenna 81, the signal processing circuit 82, and the temperature sensor 85. The communication device 8 is, for example, a mobile terminal (for example, a smartphone). It is noted that the communication device 8 is not limited to the mobile terminal and may be, for example, a wearable terminal (for example, a smart watch).

The radio frequency module 1 is configured to amplify a transmission signal (radio frequency signal) from the signal processing circuit 82 and outputs the transmission signal to the antenna 81. The radio frequency module 1 is also configured to amplify a reception signal (radio frequency signal) received at the antenna 81 and output the reception signal to the signal processing circuit 82. The radio frequency module 1 is controlled, for example, by the signal processing circuit 82.

In an exemplary aspect, the radio frequency module 1 is a module that can be configured to support, for example, fourth-generation mobile communication (4G) standards and fifth-generation mobile communication (5G) standards. Examples of the 4G standards include the third generation partnership project (3GPP)® and long term evolution (LTE)® standards. Examples of the 5G standards include 5G new radio (NR). The radio frequency module 1 is a module that can be configured to support carrier aggregation and dual connectivity.

### 3.1 Antenna

The antenna 81 is connected to the external connection terminal 34 of the radio frequency module 1. The antenna 81 has a transmission function of radiating, as a radio wave, a transmission signal output from the radio frequency module 1 and a reception function of receiving a reception signal as a radio wave from the outside and outputting the reception signal to the radio frequency module 1.

### 3.2 Signal Processing Circuit

The signal processing circuit 82 is connected to the radio frequency module 1. The signal processing circuit 82 processes a radio frequency signal passing through the radio frequency module 1. In more detail, the signal processing circuit 82 is configured to perform signal processing of a transmission signal to be output to the radio frequency module 1. The signal processing circuit 82 is also configured to perform signal processing of a reception signal received from the radio frequency module 1.

The signal processing circuit 82 includes a baseband signal processing circuit 83 and a RF signal processing circuit 84.

The baseband signal processing circuit 83 is, for example, a baseband integrated circuit (BBIC).

The baseband signal processing circuit 83 performs predetermined signal processing of a signal from the outside of the signal processing circuit 82. In more detail, the baseband signal processing circuit 83 generates a transmission signal from a baseband signal (for example, an audio signal or an image signal) from the outside of the signal processing circuit 82 and outputs the generated transmission signal to the RF signal processing circuit 84.

The baseband signal processing circuit 83 performs predetermined signal processing of a signal from the RF signal processing circuit 84. In more detail, the baseband signal processing circuit 83 outputs, to the outside, a reception signal received from the RF signal processing circuit 84. The reception signal processed by the baseband signal processing circuit 83 is used as, for example, an image signal for image display or an audio signal for a telephone call.

The RF signal processing circuit 84 is, for example, a radio frequency integrated circuit (RFIC) and performs signal processing of radio frequency signals (the transmission signal and the reception signal).

The RF signal processing circuit 84 performs signal processing of the transmission signal output from the baseband signal processing circuit 83 and outputs the transmission signal subjected to the signal processing to the radio frequency module 1. Specifically, the RF signal processing circuit 84 performs signal processing such as upconverting of the transmission signal output from the baseband signal processing circuit 83 and outputs the transmission signal subjected to the signal processing to a transmit path of the radio frequency module 1.

The RF signal processing circuit 84 performs signal processing of a reception signal output from the radio frequency module 1 and outputs the reception signal subjected to the signal processing to the baseband signal processing circuit 83. Specifically, the RF signal processing circuit 84 performs signal processing such as downconverting the reception signal output from the receive path of the radio frequency module 1 and outputs the reception signal subjected to the signal processing to the baseband signal processing circuit 83.

### 3.3 Temperature Sensor

As illustrated in FIG. 1, the temperature sensor 85 is installed in the housing (not illustrated) of the communication device 8. The temperature sensor 85 is disposed, for example, on a mother board (not illustrated) where the radio frequency module 1 is disposed. The temperature sensor 85 is installed, for example, near at least one of the radio frequency module 1 or the tracker module 9.

The temperature sensor 85 measures the ambient temperature of the installation place of the temperature sensor 85. In more detail, the temperature sensor 85 measures the ambient temperature of the radio frequency module 1 and the tracker module 9.

### 3.4 Tracker Module

As illustrated in FIG. 1, the tracker module 9 is configured to output a power supply voltage to the power amplifier 2. The tracker module 9 is used, for example, for the communication device 8. In more detail, the tracker module 9 is used for the communication device 8 together with the power amplifier 2 included in the radio frequency module 1. The tracker module 9 is connected to a battery (not illustrated) of a terminal or the like equipped with the radio frequency module 1, and the tracker module 9 is supplied with a battery voltage from the battery.

In some exemplary embodiments, when the power amplifier 2 amplifies a transmission signal by using the power supply voltage from the tracker module 9, an envelope tracking method (hereinafter, referred to as an ET method) is used. The tracker module 9 outputs the power supply voltage to the power amplifier 2 by the ET method.

The ET method is a method in which the amplitude level of a power supply voltage across an amplification device of a power amplifier is changed based on the amplitude of the envelope of a radio frequency signal. In more detail, the ET method is a method in which the envelope of the amplitude of a transmission signal (radio frequency signal) input to the amplification device of the power amplifier is detected, and the amplitude level of the power supply voltage across the amplification device is changed based on the envelope. The use of the ET method enables power loss to be reduced more and higher efficiency to be achieved than in a case where the amplitude level of the power supply voltage is constant.

The ET method includes an analog envelope tracking method (hereinafter, referred to as an analog ET method) and a digital envelope tracking method (hereinafter, referred to as a digital ET method).

The analog ET method is a method in which the envelope of the amplitude of a transmission signal (radio frequency signal) input to the amplification device of the power amplifier is continuously detected, and the amplitude level of the power supply voltage across the amplification device is changed based on the continuously detected envelope. In the analog ET method, the envelope is continuously detected, and thus the amplitude level of the power supply voltage is changed continuously.

In a case where the analog ET method is used in exemplary Embodiment 1, the tracker module 9 continuously detects the envelope of the amplitude of a first transmission signal input to each of a plurality of power amplifiers 2 and outputs, to the power amplifier 2, the power supply voltage the amplitude level of which is continuously changed based on the continuously detected envelope.

The digital ET method is a method in which the envelope of the amplitude of a transmission signal (radio frequency signal) input to the amplification device of the power amplifier is discretely detected, and the amplitude level of the power supply voltage across the amplification device is changed based on the discretely detected envelope. In the digital ET method, the amplitude level of the transmission signal is detected at regular intervals, not continuously, and the detected amplitude level is quantized. In the digital ET method, the envelope is discretely detected, and thus the amplitude level of the power supply voltage is changed discretely.

In a case where the digital ET method is used in exemplary Embodiment 1, the tracker module 9 discretely detects the envelope of the amplitude of the transmission signal input to the power amplifier 2 and outputs, to the power amplifier 2, the power supply voltage the amplitude level of which is discretely changed based on the discretely detected envelope.

The tracker module 9 generates the power supply voltage. The tracker module 9 is configured to output the power supply voltage to the power amplifier 2. In more detail, the tracker module 9 generates the power supply voltage with the amplitude level based on the envelope of the amplitude of the transmission signal and outputs the generated power supply voltage to the power amplifier 2.

The tracker module 9 is connected to the signal processing circuit 82, and a power control signal is input from the signal processing circuit 82. The tracker module 9 generates the power supply voltage based on the input power control signal. At this time, the tracker module 9 changes the amplitude of the power supply voltage based on the power control signal from the signal processing circuit 82. In other words, the tracker module 9 performs envelope tracking in which the power supply voltage is generated, the power supply voltage varying based on the envelope of the amplitude of the radio frequency signal output from the signal processing circuit 82.

### 4. Operations of Radio Frequency Module

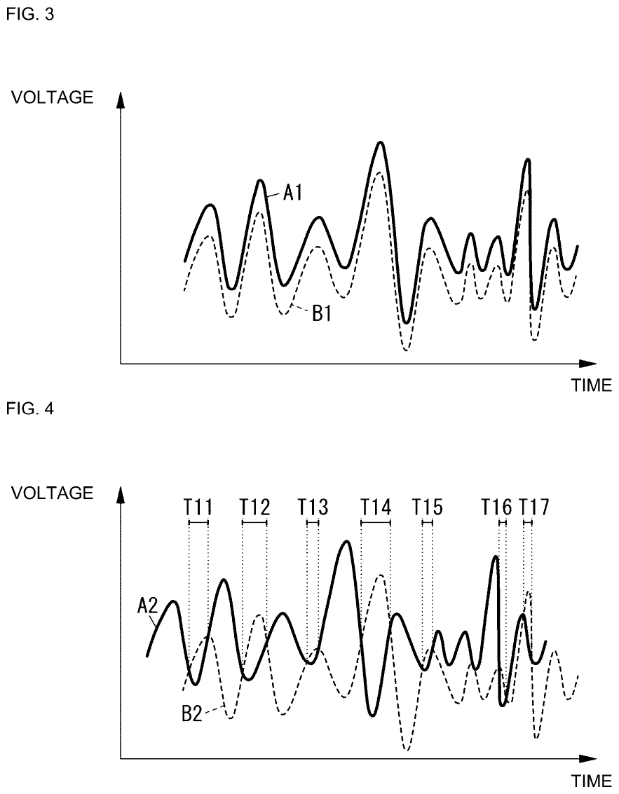

Operations of the radio frequency module 1 according to exemplary Embodiment 1 will then be described with reference to FIGS. 3 and 4.

In the radio frequency module 1 according to exemplary Embodiment 1, a path between the tracker module 9 and the power amplifier 2 is selected from among the plurality of paths P1 to P3 based on the ambient temperature of the radio frequency module 1. A waveform A1 of the power supply voltage may be delayed, and thus the waveform A1 of the power supply voltage may be synchronized with a waveform B1 of a signal passing through the power amplifier 2, as illustrated in FIG. 3.

In contrast, since there is one path between the tracker module 9 and the power amplifier 2 in a radio frequency module in Comparative Example 1, a waveform A2 of the power supply voltage does not synchronize with the waveform B2 of the signal amplified by the power amplifier 2, as illustrated in FIG. 4. This causes time periods T11 to T17 involving insufficient power supply voltages and thus causes distortion in the signal amplified by and output from the power amplifier 2.

As described above, in the radio frequency module 1 according to exemplary Embodiment 1, the delay in the power supply voltage may be adjusted in response to the change in the ambient temperature of the radio frequency module 1.

### 5. Effects

In the radio frequency module 1 according to exemplary Embodiment 1, one of the plurality of paths P1 to P3 involved with mutually different delay times selectively connects the external connection terminal 31 and the power amplifier 2. A delay time appropriate for the temperature may thereby be selected, and characteristic deterioration with temperature variations may thus be reduced.

In the radio frequency module 1 according to exemplary Embodiment 1, the switch 4 performs switching of the path connecting the external connection terminal 31 and the power amplifier 2 on the temperature basis. A path involved with a more appropriate delay time at the temperature may thereby be selected.

In the radio frequency module 1 according to exemplary Embodiment 1, at least one of the plurality of paths P1 to P3 is formed solely from the wiring conductor. The number of elements for causing the delay times may thereby be reduced, and thus paths involved with delay time may be formed readily.

In the radio frequency module 1 according to exemplary Embodiment 1, the delay circuit 5 including the RC circuit having the resistor 51 and the capacitor 52 is disposed on at least one of the plurality of paths P1 to P3. The delay time thereof may thereby be adjusted readily.

In the communication device 8 according to exemplary Embodiment 1, a delay time appropriate for the temperature may be selected in the radio frequency module 1, and thus characteristic deterioration with temperature variations may be reduced.

### 6. Modification

Hereinafter, a modification of exemplary Embodiment 1 will be described.

In a radio frequency module 1 according to the modification of exemplary Embodiment 1, the power supply voltage is output to the power amplifier 2 by the digital ET method.

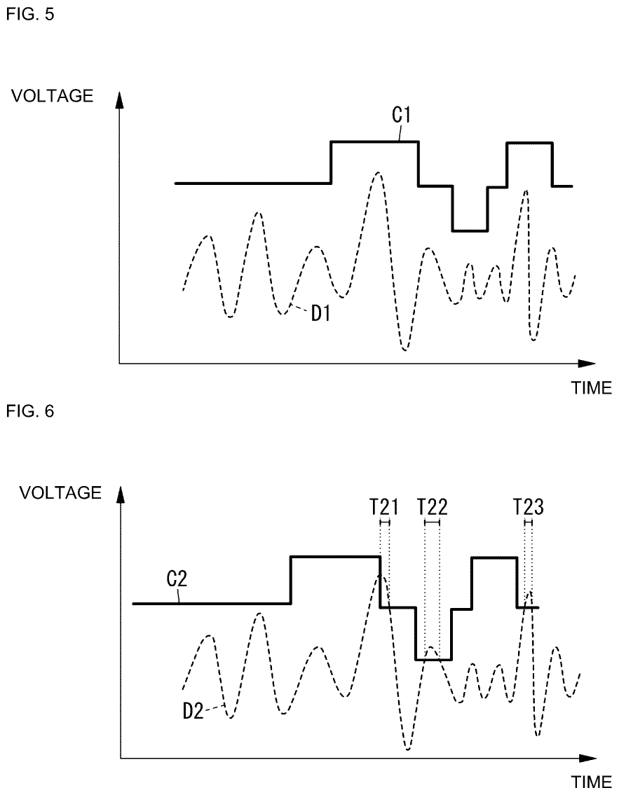

In the radio frequency module 1 according to the modification of exemplary Embodiment 1, a path between the tracker module 9 and the power amplifier 2 is selected from among the plurality of paths P1 to P3 based on the ambient temperature of the radio frequency module 1. A waveform C1 of the power supply voltage may thereby be delayed, and thus the waveform C1 of the power supply voltage may be synchronized with the waveform D1 of a signal passing through the power amplifier 2, as illustrated in FIG. 5.

In contrast, since there is one path between the tracker module 9 and the power amplifier 2 in a radio frequency module in Comparative Example 2, a waveform C2 of the power supply voltage does not synchronize with the waveform D2 of the signal amplified by the power amplifier 2, as illustrated in FIG. 6. This causes time periods T21 to T23 involving insufficient power supply voltages and thus causes distortion in the signal amplified by and output from the power amplifier 2.

As described above, in the radio frequency module 1 according to the modification of exemplary Embodiment 1, the delay in the power supply voltage may be adjusted in response to the change in the ambient temperature of the radio frequency module 1.

The radio frequency module 1 according to the modification above also exerts the same effects as those of the radio frequency module 1 according to exemplary Embodiment 1.

### Exemplary Embodiment 2

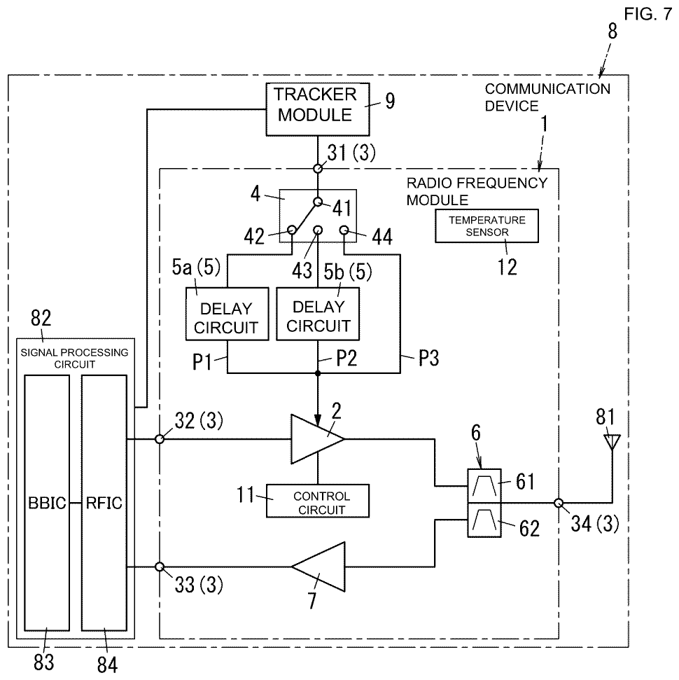

A radio frequency module 1 according to exemplary Embodiment 2 is different from the radio frequency module (see FIG. 1) according to exemplary Embodiment 1 in a point that the radio frequency module 1 includes a temperature sensor 12, as illustrated in FIG. 7. For the radio frequency module 1 according to exemplary Embodiment 2, the same components as those of the radio frequency module 1 according to exemplary Embodiment 1 are denoted by the same reference numerals, and description thereof is omitted.

### 1. Configuration

As illustrated in FIG. 7, the radio frequency module 1 according to exemplary Embodiment 2 includes the power amplifier 2, the plurality of (in the illustrated example, four) external connection terminals 3, the switch 4, the plurality of (in the illustrated example, two) delay circuits 5, the duplexer 6, the low-noise amplifier 7, the control circuit 11, and the temperature sensor 12.

### 1.1 Temperature Sensor

The temperature sensor 12 measures the ambient temperature of the radio frequency module 1 and the tracker module 9. The temperature sensor 12 is disposed, for example, on a mounting substrate (not illustrated) where the power amplifier 2 is disposed.

### 1.2 Switch

The switch 4 of exemplary Embodiment 2 performs switching of the path connecting the external connection terminal 31 and the power amplifier 2 based on the temperature measured with the temperature sensor 12. In more detail, the switch 4 performs switching of the path connecting the external connection terminal 31 and the power amplifier 2 based on the temperature measured with the temperature sensor 12 and association between the temperature and the path. The association between the temperature and the path is stored, for example, in a memory (not illustrated) of the radio frequency module 1. The switch 4 performs switching of the path connecting the external connection terminal 31 and the power amplifier 2 from among the plurality of paths P1 to P3 based on information regarding the path associated with the temperature measured with the temperature sensor 12. For the switch 4 of exemplary Embodiment 2, description of the same configuration and functions as those of the switch 4 (see FIG. 1) of exemplary Embodiment 1 is omitted.

### 2. Effects

The radio frequency module 1 according to exemplary Embodiment 2 is provided with the temperature sensor 12. A path involved with a more appropriate delay time at the temperature measured with the temperature sensor 12 may thereby be selected.

### 3. Modification

In the radio frequency module 1 according to exemplary Embodiment 2, the power supply voltage may be output from the tracker module 9 to the power amplifier 2 by any of the analog ET method and the digital ET method.

The radio frequency module 1 according to the modification above also exerts the same effects as those of the radio frequency module 1 according to exemplary Embodiment 2.

### Exemplary Embodiment 3

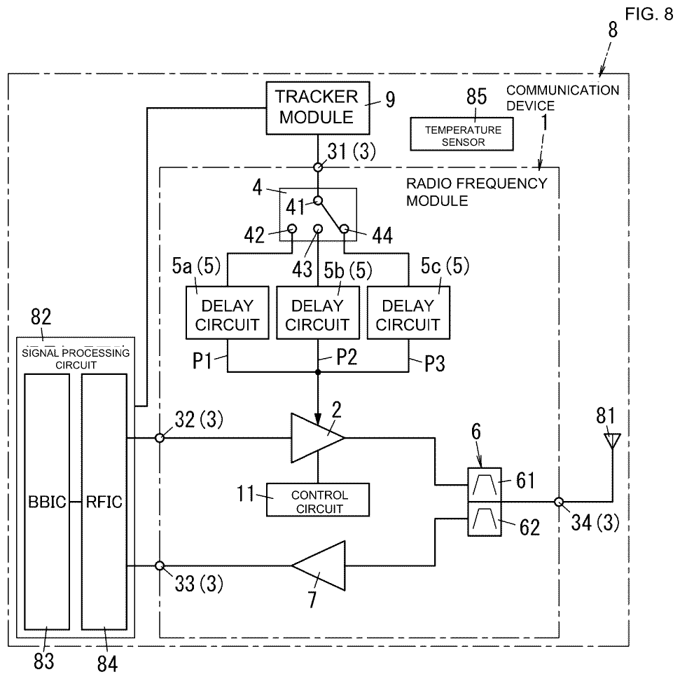

As illustrated in FIG. 8, a radio frequency module according to exemplary Embodiment 3 is different from the radio frequency module 1 according to exemplary Embodiment 1 (see FIG. 1) in a point that each of the plurality of paths P1 to P3 has a corresponding one of the delay circuits 5 including the respective RC circuits. For a radio frequency module 1 according to exemplary Embodiment 3, the same components as those of the radio frequency module 1 according to exemplary Embodiment 1 are denoted by the same reference numerals, and description thereof is omitted.

### 1. Configuration

As illustrated in FIG. 8, the radio frequency module 1 according to exemplary Embodiment 3 includes the power amplifier 2, the plurality of (in the illustrated example, four) external connection terminals 3, the switch 4, the plurality of (in the illustrated example, three) delay circuits 5, the duplexer 6, the low-noise amplifier 7, and the control circuit 11.

### 1.1 Delay Circuits

As illustrated in FIG. 8, each of the plurality of paths P1 to P3 has a corresponding one of the plurality of delay circuits 5 disposed thereon. The plurality of delay circuits 5 include the delay circuit 5a, the delay circuit 5b, and a delay circuit 5c.

The delay circuit 5a is disposed on the path P1 between the external connection terminal 31 and the power amplifier 2. In more detail, the delay circuit 5a is disposed on a path included in the path P1 and located between the selection terminal 42 of the switch 4 and the power amplifier 2.

In some exemplary embodiments, when the common terminal 41 is connected to the selection terminal 42 in the switch 4, the delay circuit 5a serves as a supply path for the power supply voltage and delays the power supply voltage. In contrast, when the common terminal 41 of the switch 4 is not connected to the selection terminal 42, the delay circuit 5a does not serve as the supply path for the power supply voltage.

The delay circuit 5b is disposed on the path P2 between the external connection terminal 31 and the power amplifier 2. In more detail, the delay circuit 5b is disposed on a path included in the path P2 and located between the selection terminal 43 of the switch 4 and the power amplifier 2.

In some exemplary embodiments, when the common terminal 41 is connected to the selection terminal 43 in the switch 4, the delay circuit 5b serves as the supply path for the power supply voltage and delays the power supply voltage. In contrast, when the common terminal 41 of the switch 4 is not connected to the selection terminal 43, the delay circuit 5b does not serve as the supply path for the power supply voltage.

The delay circuit 5c is disposed on the path P3 between the external connection terminal 31 and the power amplifier 2. In more detail, the delay circuit 5c is disposed on a path included in the path P3 and located between the selection terminal 44 of the switch 4 and the power amplifier 2.

In some exemplary embodiments, when the common terminal 41 is connected to the selection terminal 44 in the switch 4, the delay circuit 5c serves as the supply path for the power supply voltage and delays the power supply voltage. In contrast, when the common terminal 41 of the switch 4 is not connected to the selection terminal 44, the delay circuit 5c does not serve as the supply path for the power supply voltage.

### 1.2 Circuit Configuration of Delay Circuits

Each delay circuit 5 of exemplary Embodiment 3 includes the RC circuit having the resistor 51 (see FIG. 2) and the capacitor 52 (see FIG. 2) as main components, like the delay circuits 5 of exemplary Embodiment 1. The delay circuit 5 has the resistor 51 and the capacitor 52.

Each resistor 51 is disposed on a corresponding one of the paths between the external connection terminal 31 and the power amplifier 2. For example, the resistor 51 of the delay circuit 5a is disposed on the path P1 between the external connection terminal 31 and the power amplifier 2. The resistor 51 of the delay circuit 5b is disposed on the path P2 between the external connection terminal 31 and the power amplifier 2. The resistor 51 of the delay circuit 5c is disposed on the path P3 between the external connection terminal 31 and the power amplifier 2. In more detail, the resistor 51 is disposed on the corresponding path between the switch 4 and the power amplifier 2. For example, the resistor 51 of the delay circuit 5a is disposed on a path included in the path P1 and located between the selection terminal 42 of the switch 4 and the power amplifier 2. The resistor 51 of the delay circuit 5b is disposed on a path included in the path P2 and located between the selection terminal 43 of the switch 4 and the power amplifier 2. The resistor 51 of the delay circuit 5c is disposed on a path included in the path P3 and located between the selection terminal 44 of the switch 4 and the power amplifier 2.

Each capacitor 52 is disposed on a corresponding one of paths between the ground and the corresponding path between the external connection terminal 31 and the power amplifier 2. For example, the capacitor 52 of the delay circuit 5a is disposed on a path between the ground and the path P1 between the external connection terminal 31 and the power amplifier 2. The capacitor 52 of the delay circuit 5b is disposed on a path between the ground and the path P2 between the external connection terminal 31 and the power amplifier 2. The capacitor 52 of the delay circuit 5c is disposed on a path between the ground and the path P3 between the external connection terminal 31 and the power amplifier 2. In more detail, the capacitor 52 is disposed on the path between the ground and the node N1 on the path between the resistor 51 and the power amplifier 2. For example, the capacitor 52 of the delay circuit 5a is disposed on a path between the ground and the node N1 on a path included in the path P1 and located between the selection terminal 42 of the switch 4 and the power amplifier 2. The capacitor 52 of the delay circuit 5b is disposed on a path between the ground and the node N1 on a path included in the path P2 and located between the selection terminal 43 of the switch 4 and the power amplifier 2. The capacitor 52 of the delay circuit 5c is disposed on a path between the ground and the node N1 on a path included in the path P3 and located between the selection terminal 44 of the switch 4 and the power amplifier 2.

Each delay circuit 5 of exemplary Embodiment 3 adjusts a time of delay in output relative to input by using respective time constants of the resistor 51 and the capacitor 52, like the delay circuits 5 of exemplary Embodiment 1. In more detail, the delay circuit 5 adjusts the delay time for the power supply voltage by using the resistance value of the resistor 51 and the capacitance of the capacitor 52.

### 1.3 Path Switching

As illustrated in FIG. 8, the delay circuit 5a, the delay circuit 5b, and the delay circuit 5c are respectively disposed on the path P1, the path P2, and the path P3 of the plurality of paths P1 to P3. The plurality of paths P1 to P3 are involved with mutually different delay times.

The switch 4 selectively performs switching of the path connecting the external connection terminal 31 and the power amplifier 2 from among the plurality of paths P1 to P3. A delay time appropriate for the temperature may thereby be selected, and characteristic deterioration with temperature variations may thus be reduced.

The switch 4 performs switching of the path connecting the external connection terminal 31 and the power amplifier 2 on a temperature basis. In more detail, the switch 4 performs switching of the path connecting the external connection terminal 31 and the power amplifier 2 based on temperature measured with the temperature sensor 85 and association between the temperature and the path. The association between the temperature and the path is stored, for example, in a memory (not illustrated) of the radio frequency module 1. The switch 4 performs switching of the path connecting the external connection terminal 31 and the power amplifier 2 from among the plurality of paths P1 to P3 based on information regarding the path associated with the temperature measured with the temperature sensor 85.

### 2. Effects

In the radio frequency module 1 according to exemplary Embodiment 3, each of the plurality of paths P1 to P3 is provided with the delay circuit 5 including the RC circuit having the resistor 51 and the capacitor 52. The delay time thereof may thereby be adjusted readily.

### 3. Modification

In the radio frequency module 1 according to exemplary Embodiment 3, the power supply voltage may be output from the tracker module 9 to the power amplifier 2 by any of the analog ET method and the digital ET method.

The radio frequency module 1 according to the modification above also exerts the same effects as those of the radio frequency module 1 according to exemplary Embodiment 3.

### Exemplary Embodiment 4

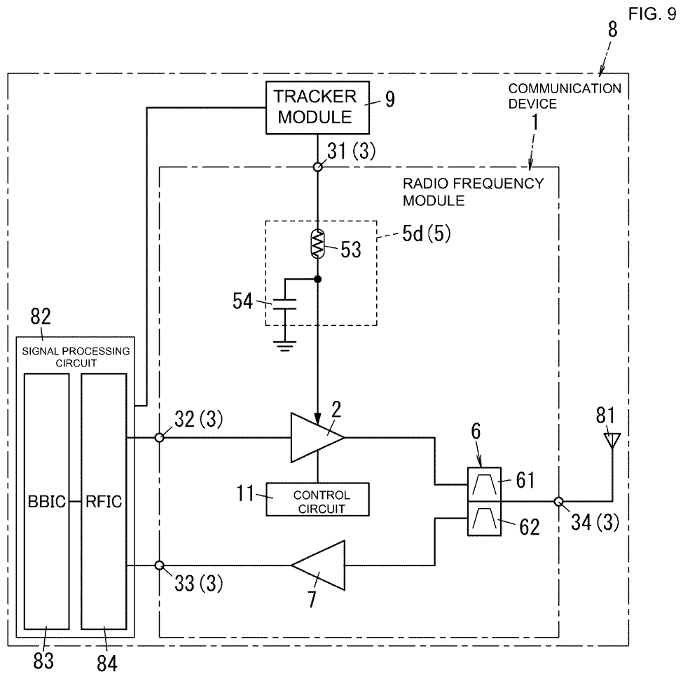

A radio frequency module according to exemplary Embodiment 4 is different from the radio frequency module 1 (see FIG. 1) according to exemplary Embodiment 1 in a point that the radio frequency module includes a thermistor 53, as illustrated in FIG. 9. For a radio frequency module 1 according to exemplary Embodiment 4, the same components as those of the radio frequency module 1 according to exemplary Embodiment 1 are denoted by the same reference numerals, and description thereof is omitted.

### 1. Configuration

As illustrated in FIG. 9, the radio frequency module 1 according to exemplary Embodiment 4 includes the power amplifier 2, the plurality of (in the illustrated example, four) external connection terminals 3, a delay circuit 5d, the duplexer 6, the low-noise amplifier 7, and the control circuit 11.

### 1.1 Power Amplifier

As illustrated in FIG. 9, the power amplifier 2 amplifies a transmission signal from the signal processing circuit 82 and outputs the transmission signal, like the power amplifier 2 of exemplary Embodiment 1 (see FIG. 1).

### 1.2 External Connection Terminals

As illustrated in FIG. 9, the plurality of external connection terminals 3 include the external connection terminal 31, the external connection terminal 32, the external connection terminal 33, and the external connection terminal 34.

### 1.3 Delay Circuits

As illustrated in FIG. 9, the delay circuit 5d has the thermistor 53 and a capacitor 54. The delay circuit 5d is disposed on a path between the external connection terminal 31 and the power amplifier 2.

The thermistor 53 is connected to the path connecting the external connection terminal 31 and the power amplifier 2. In more detail, a first end of the thermistor 53 is connected to the external connection terminal 31, and a second end of the thermistor 53 is connected to the power amplifier 2.

The capacitor 54 is connected to a path between the ground and a path between the thermistor 53 and the power amplifier 2. In more detail, a first end of the capacitor 54 is connected to the path between the thermistor 53 and the power amplifier 2, and a second end of the capacitor 54 is connected to the ground.

For the delay circuit 5d of exemplary Embodiment 4, description of the same configuration and functions as those of the delay circuits 5 (see FIG. 1) of exemplary Embodiment 1 is omitted.

### 1.4 Path

As illustrated in FIG. 9, the delay circuit 5d adjusts a delay time for the power supply voltage in such a manner that the resistance value of the thermistor 53 is changed on a temperature basis on the path connecting the external connection terminal 31 and the power amplifier 2.

### 2. Effects

In the radio frequency module 1 according to exemplary Embodiment 4, the thermistor 53 is connected to the path connecting the external connection terminal 31 and the power amplifier 2. A temperature-appropriate delay time may thereby be selected, and characteristic deterioration with temperature variations may thus be reduced.

### 3. Modification

In the radio frequency module 1 according to exemplary Embodiment 4, the power supply voltage may be output from the tracker module 9 to the power amplifier 2 by any of the analog ET method and the digital control.

The radio frequency module 1 according to the modification above also exerts the same effects as those of the radio frequency module 1 according to exemplary Embodiment 4.

The embodiments and the modifications described above are merely part of various embodiments and modifications of the present disclosure. Various changes may be made to the embodiments and the modifications in designing or the like as long as the object of the present disclosure is achievable.

This specification discloses the following exemplary aspects.

A radio frequency module (1) according to a first exemplary aspect includes a power amplifier (2), an external connection terminal (31), and a switch (4). The external connection terminal (31) is connected to a tracker module (9) and the power amplifier (2). The tracker module (9) outputs a power supply voltage to the power amplifier (2). The switch (4) selectively performs switching of a path connecting the external connection terminal (31) and the power amplifier (2) from among a plurality of paths (P1 to P3) involved with mutually different delay times.

With the radio frequency module (1) according to the first exemplary aspect, a temperature-appropriate delay time may be selected, and thus characteristic deterioration with temperature variations may be reduced.

In the first exemplary aspect, in the radio frequency module (1) according to a second exemplary aspect, the switch (4) performs switching of the path connecting the external connection terminal (31) and the power amplifier (2) on a temperature basis.

With the radio frequency module (1) according to the second exemplary aspect, a path involved with a more appropriate delay time at the temperature may be selected.

In the second exemplary aspect, the radio frequency module (1) according to a third exemplary aspect further includes a temperature sensor (12). The switch (4) performs switching of the path connecting the external connection terminal (31) and the power amplifier (2) based on temperature measured with the temperature sensor (12).

With the radio frequency module (1) according to the third exemplary aspect, a path involved with a more appropriate delay time at the temperature measured with the temperature sensor (12) may be selected.

In any one of the first to third exemplary aspects, in the radio frequency module (1) according to a fourth exemplary aspect, at least one of the plurality of paths (P1 to P3) is formed solely from a wiring conductor.

With the radio frequency module (1) according to the fourth exemplary aspect, the number of elements for causing the delay time may be reduced, and thus a path involved with the delay time may be formed readily.

In any one of the first to third exemplary aspects, the radio frequency module (1) according to a fifth exemplary aspect further includes a delay circuit (5). The delay circuit (5) is disposed on at least one of the plurality of paths (P1 to P3). The delay circuit (5) includes an RC circuit. The RC circuit has a resistor (51) and a capacitor (52).

With the radio frequency module (1) according to the fifth exemplary aspect, the delay time may be adjusted readily.

In any one of the first to third exemplary aspects, the radio frequency module (1) according to a sixth exemplary aspect further includes a plurality of the delay circuits (5). Each of the plurality of paths (P1 to P3) has a corresponding one of the plurality of delay circuits (5). Each of the plurality of delay circuits (5) includes an RC circuit. The RC circuit has a resistor (51) and a capacitor (52).

With the radio frequency module (1) according to the sixth exemplary aspect, the delay time may be adjusted readily.

A radio frequency module (1) according to a seventh exemplary aspect includes a power amplifier (2), an external connection terminal (31), and a thermistor (53). The external connection terminal (31) is connected to a tracker module (9) and the power amplifier (2). The tracker module (9) outputs a power supply voltage to the power amplifier (2). The thermistor (53) is connected to a path connecting the external connection terminal (31) and the power amplifier (2).

With the radio frequency module (1) according to the seventh exemplary aspect, a temperature-appropriate delay time may be selected, and thus characteristic deterioration with temperature variations may be reduced.

A communication device (8) according to an eighth exemplary aspect includes the radio frequency module (1) according to one of the first to seventh exemplary aspects, a tracker module (9), and a signal processing circuit (82). The signal processing circuit (82) is connected to the radio frequency module (1).

With the communication device (8) according to the eighth exemplary aspect, a temperature-appropriate delay time may be selected in the radio frequency module (1), and thus characteristic deterioration with temperature variations may be reduced.

In general, the description of the aspects disclosed should be considered as being illustrative in all respects and not being restrictive. The scope of the present disclosure is shown by the claims rather than by the above description, and is intended to include meanings equivalent to the claims and all changes in the scope. While preferred aspects of the invention have been described above, it is to be understood that variations and modifications will be apparent to those skilled in the art without departing from the scope and spirit of the invention.

What is claimed:

1. A radio frequency module comprising:
a power amplifier;
an external connection terminal configured to receive a power supply voltage that is output from a tracker module; and
a switch configured to perform switching of a selected path among a plurality of paths for coupling the external connection terminal to the power amplifier, the plurality of paths having different delay times.

2. The radio frequency module according to claim 1, wherein the switch is configured to perform the switching of the selected path based on a temperature.

3. The radio frequency module according to claim 1, further comprising:
a temperature sensor,
wherein the switch is configured to perform the switching of the selected path based on a temperature measured by the temperature sensor.

4. The radio frequency module according to claim 1, wherein at least one of the plurality of paths is formed solely from a wiring conductor.

5. The radio frequency module according to claim 1, further comprising a delay circuit that is disposed on at least one of the plurality of paths, the delay circuit including an RC circuit having a resistor and a capacitor.

6. The radio frequency module according to claim 1, further comprising a plurality of delay circuits that are respectively disposed on a corresponding one of the plurality of paths.

7. The radio frequency module according to claim 6, wherein each of the plurality of delay circuits includes an RC circuit having a resistor and a capacitor.

8. A radio frequency module comprising:
a power amplifier;
an external connection terminal configured to receive a power supply voltage that is output from a tracker module; and
a thermistor that is disposed on a path connecting the external connection terminal and the power amplifier.

9. A radio frequency module comprising:
a power amplifier;
an external connection terminal configured to receive a power supply voltage that is output from a tracker module; and
a variable delay circuit disposed on a power providing path for providing the power supply voltage from the external connection terminal to the power amplifier,
wherein the variable delay circuit is configured to adjust a delay time of the power supply voltage.

10. The radio frequency module according to claim 9, wherein the variable delay circuit is configured to adjust the delay time based on a temperature.

11. The radio frequency module according to claim 9, further comprising:
a temperature sensor,
wherein the variable delay circuit is configured to adjust the delay time based on a temperature measured by the temperature sensor.

12. The radio frequency module according to claim 9, wherein the variable delay circuit comprises a switch configured to couple one of a plurality of delay circuits into the power providing path for providing the power supply voltage from the external connection terminal to the power amplifier.

13. The radio frequency module according to claim 12, wherein at least one of the plurality of delay circuits is formed solely from a wiring conductor.

14. The radio frequency module according to claim 12, wherein at least one of the plurality of delay circuits includes an RC circuit having a resistor and a capacitor.

15. The radio frequency module according to claim 12, wherein each of the plurality of delay circuits includes an RC circuit having a resistor and a capacitor.

16. The radio frequency module according to claim 12, wherein the plurality of delay circuits includes a first delay circuit formed solely of a wiring conductor.

17. The radio frequency module according to claim 16, wherein the plurality of delay circuits includes at least a second delay circuit formed of a resistor and a capacitor.

18. The radio frequency module of claim 12, wherein the variable delay circuit comprises at least a thermistor configured to have a resistance changing with a temperature.
